(19) United States
(12) Patent Application Publication
(10) Pub. No.: US 2009/0058185 A1
(43) Pub. Date: Mar. 5, 2009

(54) Intelligent Infrastructure Power Supply Control System

(75) Inventor: Roland Schoettle, Freeport GBI (BS)

Correspondence Address: FULBRIGHT & JAWORSKI L.L.P, 2200 ROSS AVENUE, SUITE 2800, DALLAS, TX, 75201-2784, US

(73) Assignee: Optimal Innovations Inc., Bridgetown (BB)

(21) Appl. No.: 12/168,764

(22) Filed: Jul. 7, 2008

Related U.S. Application Data
(60) Provisional application No. 60/969,336, filed on Aug. 31, 2007.

(51) Int. Cl. H02J 3/14

(52) U.S. Cl. 307/35

(57) ABSTRACT

Systems and methods for managing a power grid by controlling individual power outlets with respect to a premises. The outlets are each assigned a priority level and when management is necessary, the system operates to activate/deactivate the outlets by changing the priority level. The outlets then each respond according to their individual programming. In one embodiment, certain devices, or certain outlets in a chain of outlets, may remain activated under control of auxiliary power even when the outlet is deactivated. In one embodiment, the auxiliary power is common to a group of devices.

### CROSS-REFERENCE TO RELATED APPLICATIONS

This application claims priority from U.S. Provisional Patent Application No. 60/969,336, entitled “INTELLIGENT INFRASTRUCTURE POWER SUPPLY CONTROL SYSTEM” and filed Aug. 31, 2007, the disclosure of which is hereby incorporated herein by reference.

### TECHNICAL FIELD

The present disclosure is related to power management systems, more specifically the present invention is related to managing individual outlets in a power system.

### BACKGROUND OF THE INVENTION

Electrical power is typically provided to premises, such as homes, businesses, hospitals, etc, through an electrical distribution system, such as a power grid. The power grid typically includes power transmission lines that transmit the electricity from a generator or power plant to the premises. The electricity is transmitted over high voltage power lines to a substation where the voltage is reduced and made available to the premises. Typically there are a number of premises connected to a branch of the power grid. Once the electricity reaches the premises it is distributed to power outlets, lights, and other electrical devices in the premises.

The generating capacity of the power grid is limited by the capacity of the electrical generators in the grid. When the demand or load on the power grid exceeds the generating capacity of the power grid, such as when there is high air conditioning use or a generator goes offline, some form of management of the power grid is required. This management has included buying additional electrical power from other power grids that are connected to the power grid, rolling blackouts or simply allowing brownouts. In a rolling blackout, power is temporarily turned off to a portion of the power grid. By turning off a portion of the power grid, other premises on the grid maintain their electrical power. However, a rolling blackout turns off the electrical power to all locations in that portion of the power grid without regard for the importance of the premises, or the devices, located in the blacked out portion of the grid. This can result in important devices in a premises, such as a life support system in a hospital, or a security sensor in a home premises, being turned off when the circuit branch powering the device is turned off.

In some situations, auxiliary power is used to maintain power to critical devices. In such situations, the auxiliary power must be run separately to each device. Often, the only practical method of running such auxiliary power is to connect the auxiliary source to a power breaker and thereby power the entire circuit branch. This then results in an auxiliary source that must be sized larger than is necessary to power just the critical devices.

### BRIEF SUMMARY OF THE INVENTION

The present disclosure is directed to systems and methods for managing a power grid by controlling individual power outlets with respect to a premises. The outlets are each assigned a priority level and when management is necessary, the system operates to activate/deactivate the outlets by changing the priority level. The outlets then each respond according to their individual programming. In one embodiment, certain devices, or certain outlets in a chain of outlets, may remain activated under control of auxiliary power even when the outlet is deactivated. In one embodiment, the auxiliary power is common to a group of devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating a premises electrical wiring system according to one embodiment of the invention;

FIG. 2 shows a flow diagram illustrating an example of managing the power system according to one embodiment, and

FIG. 3 shows one embodiment of a circuit for controlling priority levels of devices within the premises.

### DETAILED DESCRIPTION OF THE INVENTION

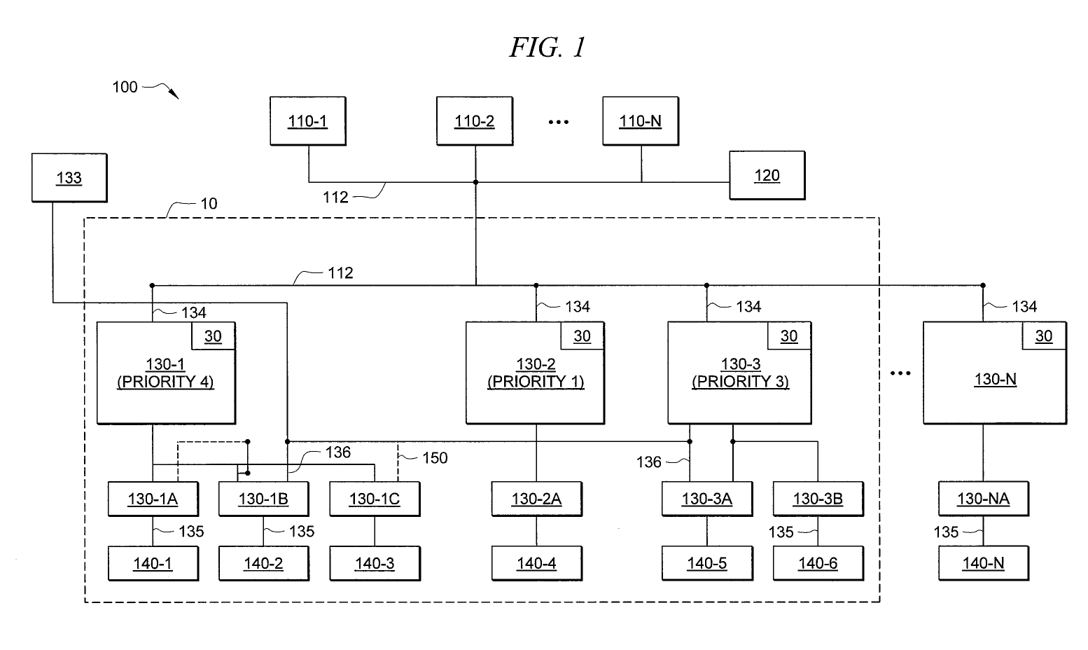

FIG. 1 is a block diagram illustrating the components of a power grid according to at least one embodiment of the present invention. Power grid 100 includes power generation units 110-1, 110-2, 110-N (however, only one need be present), distribution lines 112, power management system 120, a plurality of circuit control devices 130-1, 130-2, 130-3, 130-N controlling outlets 130-1A, 130-1B, 130-1C, 130-2A, 130-3A, 130-3B and 130-NA which in turn, control devices, such as 140-1, 140-2 to 140-N. Power grid 100 is in one embodiment a utility power grid, such as used by standard electrical utilities to provide power from the power generation units to consumers through power outlets in the consumer's premises. In another example, power grid 100 is local in nature, such as on a single premises. For example, power grid 100 can be a military installation or hospital that is isolated from a larger power grid.

Power is transmitted from power generation units 110-1, 110-2, 110-N though distribution lines 112 to one or more premises, such as premises 10. Power generation units 110-1, 110-2, 110-N can be located together at a single location, or can be spread about at a number of locations. For example, power generation unit 110-1 can be a hydroelectric power plant located at a dam, while power generation unit 110-2 can be a fossil fuel power plant located somewhere else. In another example, such as when power grid 100 is a military installation, each power generation unit 110-1, 110-2, 110-N is a generator or group of generators located at the installation.

Control devices 130-1, 130-2, 130-3, 130-N are, for example, breakers or other devices that permit electricity to be extracted from the power grid via a first electrical connection 134, and provided to devices 140-1, 140-2, 140-3, 140-N, external to the power grid via a second connection 135 facilitated by power outlets 130-1A, 130-1B, etc. Devices 140-1, 140-2, etc. can be, for example, televisions, respirators, radar units, or security monitoring devices. Depending on the arrangement and the needs of the devices, power outlets 130-1A, 130-1B to 130-C, can be, for example, standard electrical outlets, or they can be specialized connections.

Control devices 130-1, 130-2, 130-3, 130-N are typically located in breaker boxes in a central location within a building, but could be in individual rooms if desired. Typically, a building has multiple outlets that are located in various rooms or areas of the building connected to the same branch. For example, the branch controlled by device 130-1 has three outlets (130-1A, 130-1B, 130-1C) connected thereto. During heavy use periods (e.g. high heat), traditional power management approaches turn off areas of the power grid (e.g., a block or section within the power grid) in either a random or organized approach. These “rolling blackouts” often occur with little or no warning to the consumer. However, this approach simply turns off the power to a portion of the grid without concern for what facilities or equipment could be impacted. Further, this traditional approach leaves people guessing as to when they will lose their power service, and thus, unable to properly plan.

As shown in FIG. 1, control devices 130-1, 130-2, 130-3,130-N include circuitry 30 (which could be software or hardware or a combination thereof) which permits the branch controlled by that device to be remotely activated/deactivated depending on the needs of the power grid. Circuit 30 allows each outlet 130-1, 130-2, 130-3, 130-N to be assigned a priority level or depending upon how important the external devices that are connected to the outlets within the branch. Each circuit is assigned a priority level, such as 1 to 5, where priority level 1 indicates a high priority circuit and priority level 5 indicates a low priority outlet. Note that while the priority is assigned at the circuit control (breaker) level in this embodiment, the individual outlets could each have a priority level and the concepts discussed herein would still apply.

If desired, the priority level of each device could be user-controlled from time to time. This change can be accomplished remotely or by a physical switch on the outlet. In other embodiments, the priority level of the outlet can be changed by a device, such as device 140-1, that is currently plugged into the outlet. For example, if a life support system were plugged into a low priority outlet (e.g. an outlet that was assigned a priority level of 5), the life support system could be configured to change the priority level of the outlet from say, 5 to 1. When the high priority device is removed, the outlet could return to its preassigned level.

Auxiliary power source 133 can be wired to one or more power outlets, such as power outlet 130-1B via connection 136 for the purpose, as will be discussed, of providing auxiliary power to certain critical equipment when the main power is disabled. This power may be line voltage, such as 120 VAC, 220 VAC, or it may be a low voltage AC or even DC. In some embodiments, this auxiliary voltage can be wired to many outlets, such as is shown by wiring 150. When run to many outlets there would be a control device, not shown, within the outlet acting to only allow the auxiliary power to be supplied to those devices that set to receive the auxiliary power. This control can be user set from time to time, or can be set based on the type of plug used to connect the device to the receptacle, or by other means. Thus, auxiliary power supply can be separate from the main supply and common to a plurality of devices within a premises. Supply source 133 can be located on the premises or part of a larger emergency supply system that transcends the premises.

Power management system 120 is a processor or other device capable of monitoring the status of power grid 100. In one embodiment, the power management system monitors the power generation capacity of the power generation units in power grid 100. In some situations, monitor 120 is local to a particular premises. In some embodiments, power management system 120 monitors the overall load on the grid. In other embodiments, power management system 120 monitors the ratio of power generation capacity vs power load. Regardless of the method used to monitor the status of the power grid, power management system 120 uses monitored information to determine how to manage power within one or more premises.

The values calculated by power management system 120 can vary for a variety of reasons. For example, the load on the grid relative to the generating capacity can change as more or less devices 140-1, 140-2, 140-3, 140-4, 140-N demand power from grid 100. Further, one or more power generation units 110-1, 110-2, 110-N can be taken off line (e.g. maintenance, damage, etc). Each one of these events can cause a change in the status of the power grid, and may require modifications in the operation of the grid.

In one embodiment, the priority levels are determined by power management system 120 based on a predetermined set of circumstances. For example, in a five level priority system, the power management system may determine that management of the system can be done using a threshold value for maximum load on the power grid. Thus, in this example, power management system 120 monitors based on system load vs power generation capacity. For example, when the load on grid 100 is equal to 96% of the generating capacity, power management system 120 may determine that it is necessary to turn off a portion of the existing on-line power outlets. Power management system 120 then generates a signal, either wireless or wire to turn off those outlets that have been assigned priority level of 5. This signal to turn off the outlets can be transmitted to the plurality of outlets over distribution lines 112 or wirelessly. In one embodiment, this signal is simply an indication of the desired priority level and each outlet (or branch control device) detects the priority level and matches the desired level against the level set for that device under control of circuit 30. If the load vs generation capacity still falls above the threshold value then power management system 120 can send a signal for the next lowest priority level of outlets to turn off (i.e. those outlets having priority level 4). This process of deactivating power outlets can be repeated until the load on grid 100 is below the threshold value.

Power management system 120 then uses use a second threshold level to determine when to allow currently deactivated outlets to be activated. For example, power management system 120 can be programmed that when the load on grid 100 falls below 70% of the generating capacity a portion of the deactivated outlets may be activated. Power management system 120 transmits a signal to each of the deactivated outlets instructing the outlets to reactivate. Once reactivated the devices are able to draw power from grid 100. In this example, power activation/deactivation is achieved by setting a priority level for an area, or for a single premises, if desired.

When the priority for an outlet, such as outlet 1301-1 and 130-3 (which can be different priorities) is such that one or both outlets are in branches which turn off, power can remain on via power source 133, and connections 136. Sometimes the full power is not required and then the auxiliary source can be low voltage. For example, if device 140-5 is a fire sensor that has a changing circuit (not shown) that requires 110V AC, when branch 130-3 (having priority 3) becomes deactivated, sensor 140-5 can receive, for example, 9V dc via connection 136 to just power the sensor during the emergent condition.

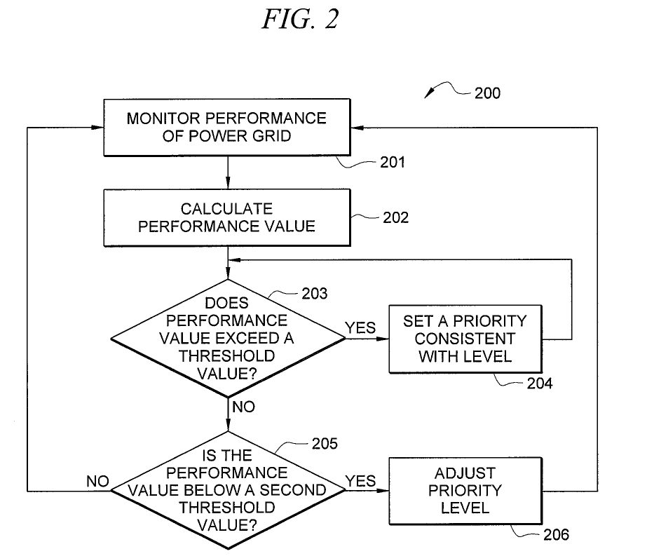

FIG. 2 is a flow diagram illustrating process 200 for managing power grid 100 having power outlets 130-1, 130-2, 130-3, 130-N according to one illustrative embodiment.

At process 201, power management system 120 monitors the performance of power grid 100 to obtain data related to the performance. This monitoring can include such things as monitoring the overall power available to the grid that can be generated by generation units 110-1, 110-2, 110-N, the overall load placed on the power grid by devices connected to outlets 130-1, 130-2, 130-3, 130-N, or other characteristics of grid 100 that may be desirable to monitor.

Based on the monitoring process 201, power management system 120 calculates a performance value for the grid based on the obtained data. This value can be compared with a threshold value, or processed through algorithms or other equations to determine if any changes need to be made to the power grid 100. This is illustrated at process 202. In one embodiment power management system 120 compares the current generation capacity of the grid against a threshold value. In another embodiment, power management system 120 compares the current generation capacity of the grid 100 against a database of generation capacities. In yet another embodiment, power management system 120 compares the current load on grid 100 with the current generation capacity of grid 100. For purposes of this discussion it will be assumed that power management system 120 is determining the load on the grid versus the available power generation capacity of the grid against a predetermined threshold value.

At process 203, power management system 120 determines if any modifications are needed to the operation of power grid 100. These modifications to the grid can include turning on/off a number of control devices, such as devices 130-1, 130-2, 130-3, 130-N. First, using the above example, power management system 120 determines, at process 203, if the current load vs generation capacity of grid 100 exceeds a threshold value. For example, the threshold value is a load of 96% of the available power. If power management system 120 determines that the ratio of load to capacity exceeds 96%, then process 204 selects the proper priority level, for example, by using a pre-established chart of priority levels of available power and a signal is sent to deactivate a portion of outlets 130-1, 130-2, 130-3, 130-N. Once the group of outlets has been deactivated, power management system 120 returns to process 203.

If the threshold value is not exceeded, process 205 determines if the ratio of load vs available power is below a second threshold level. The second threshold level is a level at which it should be safe to activate additional outlets on the grid. For example, power management system 120 can activate deactivated outlets if the ratio of load to capacity determined at process 202 is less than 70%. If the ratio is less than this second threshold value, process 206 generates a signal to change the priority thereby activating a group of outlets.

In some embodiments prior to activating outlets at process 206 additional processing can be done to ensure that the system does not get stuck in a loop where outlets are being activated and deactivated in rapid succession. For example, power management system 120 can determine this by making an assumption of an anticipated load (second performance value) that would occur if this group of outlets is activated. Alternatively, the actual increase in the load can be calculated. In other embodiments, process 206 monitors the time since the last group of outlets was deactivated. In this embodiment process 206 uses a time threshold whereby deactivated outlets remain deactivated for a minimum period of time, such as 10 minutes.

Following the execution of processes 203 and 205, and if necessary processes 204 and 206, power management system 120 returns to process 201 and continues to monitor activity on power grid 100.

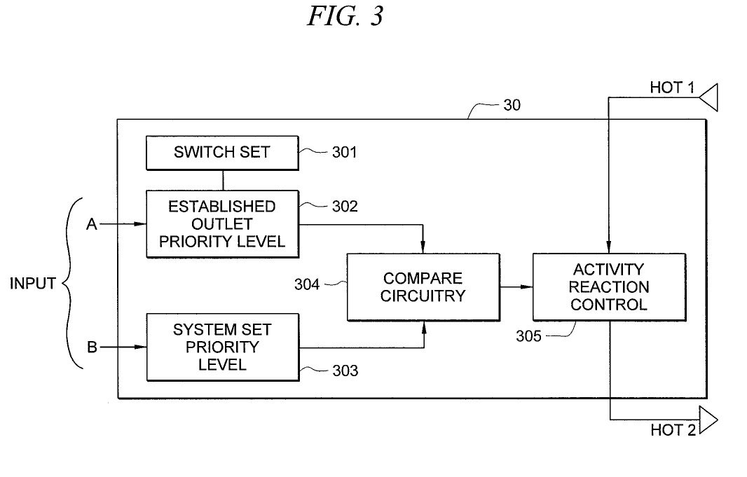

FIG. 3 shows one embodiment of a circuit, such as circuit 30, for controlling priority levels of devices with the premises. Note that while discrete blocks are shown for illustrative purposes, circuit 30 can be software based, hardware based or a combination thereof and one or more blocks can be combined if desired. The current priority is maintained in circuit 302 which could, for example, be a memory or a set of switches. One method of programming circuit 302 would be by using switches 301 or by allowing electrical signal input via input A. This can be via the premises electrical wiring to the device, wirelessly or by a separate control wire. The user can then set the priority. In some situations, the priority may be set at the factory and such a setting can be made so as to be permanent if desired.

When the system sends a priority level (again, either over the electrical wiring, a control wire or wirelessly) this level is received via input B and stored in circuitry 303. A comparison is made by circuit 304 between the priority of the device, as contained in circuit 302 and the system priority level as contained in circuit 303. If these levels are different, then switch 305 operates to either activate (close) or deactivate (open) so as to control electrical power flowing from lead hot1 to lead hot2. This switch can be mechanical in nature or electronic and, if desired can be a “dimmer” type switch such that the power is cut back for certain priorities and not completely turned off.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A power system comprising:
a plurality of outlets, each said outlet operable for providing an electrical connection to devices external to said power system; and
a control device in certain of said outlets, said control device operable for activating/deactivating said outlet electrical connection based upon received priority level signals.

2. The power system of claim 1 further comprising:
circuitry for storing, in each said control device, a priority level individual to said control device.

3. The power control device of claim 2 further comprising:
means for allowing a user to selectively change said priority level from time to time.

4. The power system of claim 1 further comprising:
circuitry for monitoring an amount of power available on a power grid, and
circuitry for sending a priority level signal based upon said amount of available power.

5. The power system of claim 4 wherein said monitoring circuitry monitors loads on said system.

6. The power system of claim 1 further comprising:
circuitry for providing at least some electrical output power from ones of said outlets in which an electrical output connection is deactivated.

7. The power system of claim 6 further comprising:
an auxiliary power source for providing at least some electrical output power to said outlets.

8. The power system of claim 1 wherein at least a portion of said plurality of outlets are connected to a secondary power source, said secondary power source providing electrical power to said outlets along a path different from a primary path for providing power to said outlets.

9. The power system of claim 1 wherein said secondary power source is shared by a plurality of said plurality of power outlets.

10. A method of managing a power grid comprising:
monitoring said power grid to obtain a performance value for said power grid;
determining if said performance value exceeds a threshold value; and
if said performance value exceeds said threshold value then, sending a control signal to allow certain electrical outlets to take action to become deactivated from said power grid.

11. The method of claim 10 wherein said control signal is a priority level signal.

12. The method of claim 11 further comprising:
circuitry associated with said outlets for individually controlling said associated outlets upon receipt of said priority signal.

13. The method of claim 12 further comprising:
providing a secondary power supply to at least a portion of said plurality of outlets, said secondary power supply available for providing power to said outlets without regard to said priority signal.

14. A power outlet comprising:
a first electrical connection to an electrical power supply;
a second connection permitting a device external to said power outlet to obtain said electrical power from said power outlet; and
a logic component responsive to signals from a power management system for activating/deactivating said power outlet so as to control electrical power to a connected external device.

15. The power outlet of claim 14 wherein said logic component comprises:
means for maintaining a priority level, said priority level indicative of a relative importance of said power outlet.

16. The power outlet of claim 15 wherein said priority level is user changeable from time to time.

17. The power outlet of claim 16 further comprising:
a switch configured to change said priority level.

18. The power outlet of claim 17 wherein said outlet is configured to receive from said device a signal to change said priority level from a default priority level to a temporary priority level.

19. The power outlet of claim 18 further comprising:
a second electrical connection, said second electrical connection providing electrical power to said power outlet.
